(19) United States
(12) Patent Application Publication
(10) Pub. No.: US 2025/0386348 A1
(43) Pub. Date: Dec. 18, 2025

(54) METHOD AND APPARATUS FOR TRANSMITTING RESOURCE CONFIGURATION INFORMATION, AND READABLE STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/879,166

(22) PCT Filed: Jun. 27, 2022
(86) PCT No.: PCT/CN2022/101682

§ 371 Date: Dec. 26, 2024

(51) Int. Cl. H04W 72/21; H04W 72/0446; H04W 72/115

(52) U.S. Cl. CPC H04W 72/21; H04W 72/0446; H04W 72/115

(57) ABSTRACT

A method for transmitting resource configuration information includes: receiving at least one configured grant physical uplink shared channel (CG-PUSCH) configuration sent by a network device, where each period of the CG-PUSCH configuration includes a plurality of CG-PUSCH resources.

### CROSS-REFERENCE TO RELATED APPLICATIONS

The present application is a U.S. National Stage of International Application No. PCT/CN2022/101682, filed on Jun. 27, 2022, the contents of which are incorporated herein by reference in their entirety for all purposes.

### BACKGROUND OF THE INVENTION

An extended reality (XR) service is one of service types supported by a 5G system, and XR includes augmented reality (AR)/virtual reality (VR)/cloud gaming, etc. An uplink XR service (for example, an AR service) is characterized by generating data in a fixed frame rate, for example, 60 frame per second (FPS) without delay jitter, a size of a packet body of each frame fluctuates according to actual situations, some frames have less data, and some frames have more data.

### SUMMARY OF THE INVENTION

The disclosure provides a method and apparatus for transmitting resource configuration information, and a readable storage medium.

In a first aspect, a method for receiving resource configuration information is provided, performed by user equipment, including: receiving at least one configured grant physical uplink shared channel (CG-PUSCH) configuration sent by a network device, where each period of the CG-PUSCH configuration includes a plurality of CG-PUSCH resources.

In a second aspect, a method for sending resource configuration information is provided, performed by a network device, including: sending at least one configured grant physical uplink shared channel (CG-PUSCH) configuration to user equipment, where each period of the CG-PUSCH configuration includes a plurality of CG-PUSCH resources.

In another aspect, a communication apparatus is provided and includes a processor and a memory, where the memory is configured to store a computer program; and

the processor is configured to perform the computer program to implement the first aspect or any one of possible designs in the first aspect.

It is to be understood that the above general description and the following detailed description are merely examples and explanatory instead of limiting the disclosure.

### BRIEF DESCRIPTION OF DRAWINGS

Accompanying drawings described here are used for providing further understanding for the examples of the disclosure and constitute a part of the present application, and examples of the examples of the disclosure and their descriptions are intended to explain the examples of the disclosure instead of constituting an inappropriate limitation on the examples of the disclosure. In the accompanying drawings: the accompanying drawings here, which are incorporated in and constitute a part of the specification, illustrate examples consistent with the examples of the disclosure and, together with the specification, serve to explain principles of the examples of the disclosure.

FIG. 1 is a schematic architectural diagram of a wireless communication system provided by an example of the disclosure.

FIG. 2 is a flowchart of a method for transmitting resource configuration information shown according to an example.

FIG. 3 is a flowchart of a method for transmitting resource configuration information shown according to an example.

FIG. 4 is a schematic diagram of a CG-PUSCH resource in one period shown according to an example.

FIG. 5 is a flowchart of a method for transmitting resource configuration information shown according to an example.

FIG. 6 is a flowchart of a method for receiving resource configuration information shown according to an example.

FIG. 7 is a flowchart of a method for receiving resource configuration information shown according to an example.

FIG. 8 is a flowchart of a method for receiving resource configuration information shown according to an example.

FIG. 9 is a flowchart of a method for sending resource configuration information shown according to an example.

FIG. 10 is a flowchart of a method for sending resource configuration information shown according to an example.

FIG. 11 is a flowchart of a method for sending resource configuration information shown according to an example.

FIG. 12 is a structural diagram of an apparatus for receiving resource configuration information shown according to an example.

FIG. 13 is a structural diagram of an apparatus for receiving resource configuration information shown according to an example.

FIG. 14 is a structural diagram of an apparatus for sending resource configuration information shown according to an example.

FIG. 15 is a structural diagram of an apparatus for sending resource configuration information shown according to an example.

### DETAILED DESCRIPTION OF THE INVENTION

The examples of the disclosure are further described with reference to the accompanying drawings and specific implementations.

The examples will be described in detail here, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the examples of the disclosure. Rather, they are merely examples of an apparatus and method consistent with some aspects of the disclosure as detailed in the appended claims.

Terms used in the examples of the disclosure are merely intended to describe specific examples but not to limit the examples of the disclosure. The singular forms “a/an” and “said” used in the examples and the appended claims of the disclosure is also intended to include a plural form unless other meanings are indicated clearly in the context. It is to be further understood that the terms “and/or” used here refers to and contains any one or all possible combinations of one or a plurality of associated listed items.

It is to be understood that various information, possibly described by using terms such as first, second and third in the examples of the disclosure, is not limited to these terms. These terms are merely used for distinguishing the same type of information. For example, without departing from the scope of the examples of the disclosure, first information may also be called second information, and similarly, the second information may also be called the first information. Depending on the context, words such as “if” and “in a case that” used here may be construed as “when . . . ”, or “while . . . ” or “in response to determining”.

The disclosure relates to the technical field of wireless communications, in particular to a method and apparatus for transmitting resource configuration information, and a readable storage medium.

In the related art, the XR service is transmitted by using periodic configured grant PUSCH (CG-PUSCH), a physical uplink shared channel (PUSCH) resource is configured for one period of the CG-PUSCH, however, the size of the packet body of the XR uplink service changes frequently, so one PUSCH resource may not meet transmission of some frames having a large data volume.

In the present method, the at least one configured grant physical uplink shared channel (CG-PUSCH) configuration sent by the network device is received by the user equipment, a service may be transmitted through the plurality of CG-PUSCH resources in each period of the CG-PUSCH configuration, thus when a data volume of each frame of the transmitted service is large, all service data can be transmitted by using the PUSCH resources in one period, and energy consumption of the user equipment is reduced.

In the present method, the at least one configured grant physical uplink shared channel (CG-PUSCH) configuration is sent to the user equipment by the network device, so that the user equipment can transmit the service through the plurality of CG-PUSCH resources in each period of the CG-PUSCH configuration, thus when a data volume of each frame of the transmitted service is large, all service data can be transmitted by using the PUSCH resources in one period, and energy consumption of the user equipment is reduced.

The examples of the disclosure are described in detail below, instances of the examples are shown in the accompanying drawings, and the same or similar reference numerals represent the same or similar elements all the time. The examples described with reference to the accompanying drawings below are examples and are intended to explain the disclosure but are not understood as a limitation on the disclosure.

As shown in FIG. 1, a method for transmitting resource configuration information provided by an example of the disclosure may be applied to a wireless communication system 100. The wireless communication system may include but is not limited to a network device 101 and user equipment 102. The user equipment 102 is configured to support carrier aggregation and may be connected to a plurality of carrier units of the network device 101, and the carrier units include one main carrier unit and one or more auxiliary carrier units.

It is to be understood that the above wireless communication system 100 may be applied not only to a low-frequency scene, but also to a high-frequency scene. Application scenes of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5^{th}-generation (5G) system, a new radio (NR) communication system or a future evolved public land mobile network (PLMN) system or the like.

The user equipment 102 shown above may be user equipment (UE), a terminal, an access terminal, a terminal unit, a terminal station, a mobile station (MS), a remote station, a remote terminal, a mobile terminal, a wireless communication device, a terminal agent or user equipment or the like. The user equipment 102 may have a wireless transceiving function and can conduct communication (such as wireless communication) with one or more network devices 101 of one or more communication systems and receive a network service provided by the network device 101. The network device 101 here includes but is not limited to a base station illustrated.

The user equipment 102 may be a cell phone, a cordless telephone, a session initiation protocol (SIP) telephone, a wireless local loop (WLL) station, a personal digital assistant (PDA) device, a handheld device with a wireless communication function, a computing device or another processing device connected to a radio modem, a vehicle-mounted device, a wearable device, user equipment in the future 5G network or user equipment in the future evolved PLMN network or the like.

The network device 101 may be the access network device (or called an access network site). The access network device refers to a device providing a network access function, such as a radio access network (RAN) base station, etc. The network device may specifically include a base station (BS) device, or a wireless resource management device including a base station device or for controlling the base station device and the like. The network device may further include a relay station (relay device), an access point, a base station in the future 5G network, a base station in the future evolved PLMN network, an NR base station or the like. The network device may be a wearable device or a vehicle-mounted device. The network device may also be a communication chip with a communication module.

For example, the network device 101 includes but is not limited to: a next generation base station (gnodeB (gNB)) in 5G, evolved node B (eNB) in the LTE system, a radio network controller (RNC), node B (NB) in a WCDMA system, a wireless controller under the CRAN system, a base station controller (BSC), a base transceiver station (BTS) in a GSM system or a CDMA system, a home base station (for example, home evolved node B or home node B (HNB)), a baseband unit (BBU), a transmitting and receiving point (TRP), a transmitting point (TP), a mobile switching center or the like.

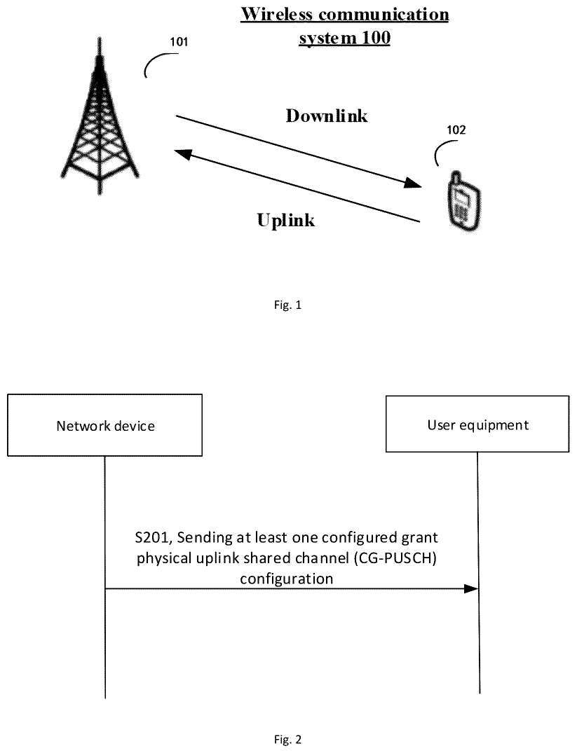

An example of the disclosure provides a method for transmitting resource configuration information. FIG. 2 is a flowchart of a method for transmitting resource configuration information shown according to an example. As shown in FIG. 2, the method includes step S201.

Step S201: at least one configured grant physical uplink shared channel (CG-PUSCH) configuration is sent to user equipment by a network device.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be detected by the network device in a belonging period can be accurately indicated.

In the example of the disclosure, the at least one configured grant physical uplink shared channel (CG-PUSCH) configuration sent by the network device is received by the user equipment, a service may be transmitted through the plurality of CG-PUSCH resources in each period of the CG-PUSCH configuration, thus when a data volume of each frame of the transmitted service is large, all service data can be transmitted by using the PUSCH resources in one period, and energy consumption of the user equipment is reduced.

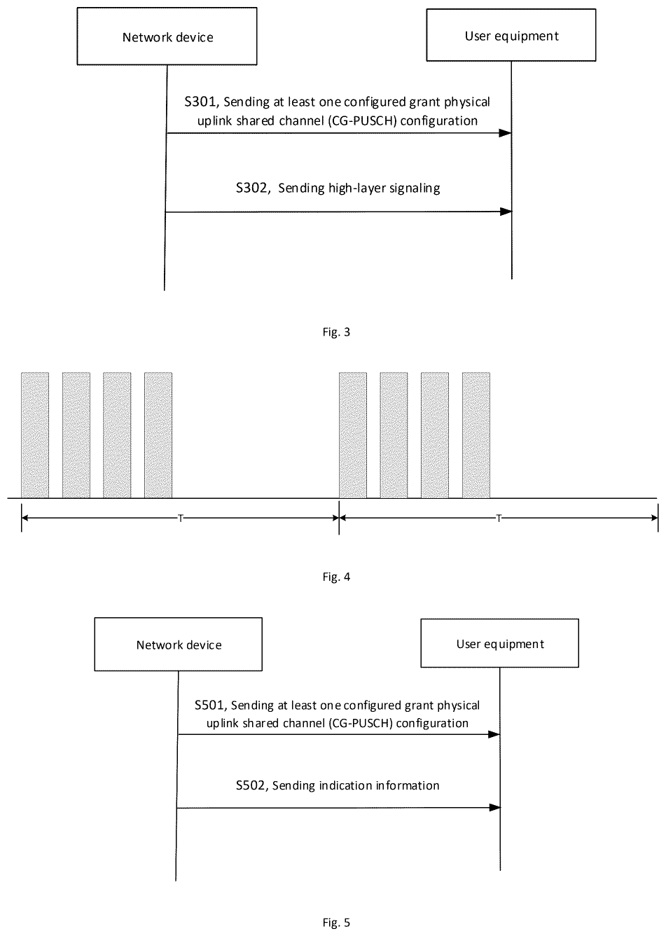

An example of the disclosure provides a method for transmitting resource configuration information. FIG. 3 is a flowchart of a method for transmitting resource configuration information shown according to an example. As shown in FIG. 3, the method includes steps S301 to S302.

Step S301: at least one configured grant physical uplink shared channel (CG-PUSCH) configuration is sent to user equipment by a network device.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be detected by the network device in a belonging period can be accurately indicated.

Step S302: high-layer signaling is sent to the user equipment by the network device.

The high-layer signaling includes information for indicating N, and a N is the number of CG-PUSCH resources included in each period of the CG-PUSCH configuration.

In an example, FIG. 4 is a schematic diagram of a CG-PUSCH resource in one period shown according to an example. As shown in FIG. 4, N is 4 in a case that each period T includes four CG-PUSCH resources.

It needs to be noted that a sequential order of step S301 and Step 302 is not limited.

An example of the disclosure provides a method for transmitting resource configuration information. FIG. 5 is a flowchart of a method for transmitting resource configuration information shown according to an example. As shown in FIG. 5, the method includes steps S501 to S502.

Step S501: at least one configured grant physical uplink shared channel (CG-PUSCH) configuration is sent to user equipment by a network device.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be detected by the network device in a belonging period can be accurately indicated.

Step S502: indication information is sent to the user equipment by the network device.

The user equipment determines according to the indication information that a number of CG-PUSCH resources included in each period of the CG-PUSCH configuration is indicated as non-numeric information.

When the number of CG-PUSCH resources included in each period is indicated as the non-numeric information, it shows that the number of CG-PUSCH resources included in each period is not fixed, the number of CG-PUSCH resources is determined according to actual scheduling situations, and the number in different periods may be the same or not. In one CG-PUSCH period, a terminal may send uplink data by using the plurality of CG-PUSCH resources till there is no to-be-transmitted uplink data.

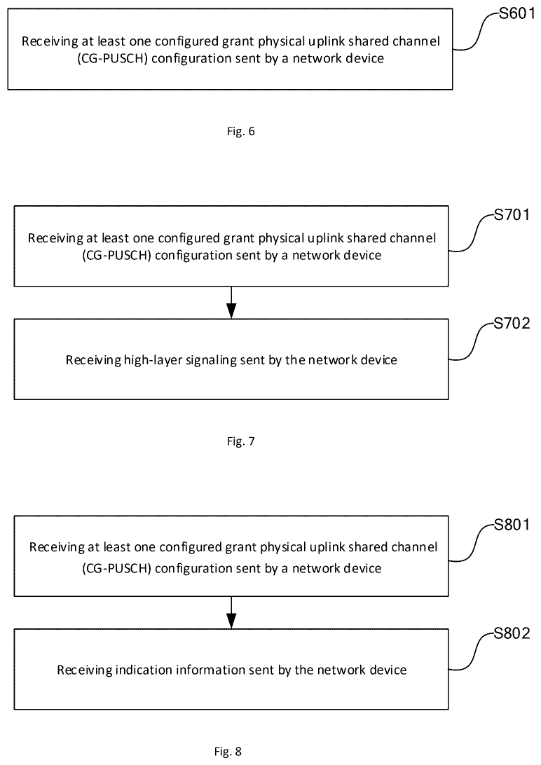

An example of the disclosure provides a method for receiving resource configuration information, performed by user equipment. FIG. 6 is a flowchart of a method for receiving resource configuration information shown according to an example. As shown in FIG. 6, the method includes step S601.

Step S601: at least one configured grant physical uplink shared channel (CG-PUSCH) configuration sent by a network device is received.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be detected by the network device in a belonging period can be accurately indicated.

An example of the disclosure provides a method for receiving resource configuration information, performed by user equipment. FIG. 7 is a flowchart of a method for receiving resource configuration information shown according to an example. As shown in FIG. 7, the method includes steps S701 to S702.

Step S701: at least one configured grant physical uplink shared channel (CG-PUSCH) configuration sent by a network device is received.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be detected by the network device in a belonging period can be accurately indicated.

Step S702: high-layer signaling sent by the network device is received.

The high-layer signaling includes information for indicating N, and the N is a number of CG-PUSCH resources included in each period of the CG-PUSCH configuration.

In an example, as shown in FIG. 4, N is 4 in a case that each period T includes four CG-PUSCH resources.

It needs to be noted that a sequential order of step S701 and Step S702 is not limited.

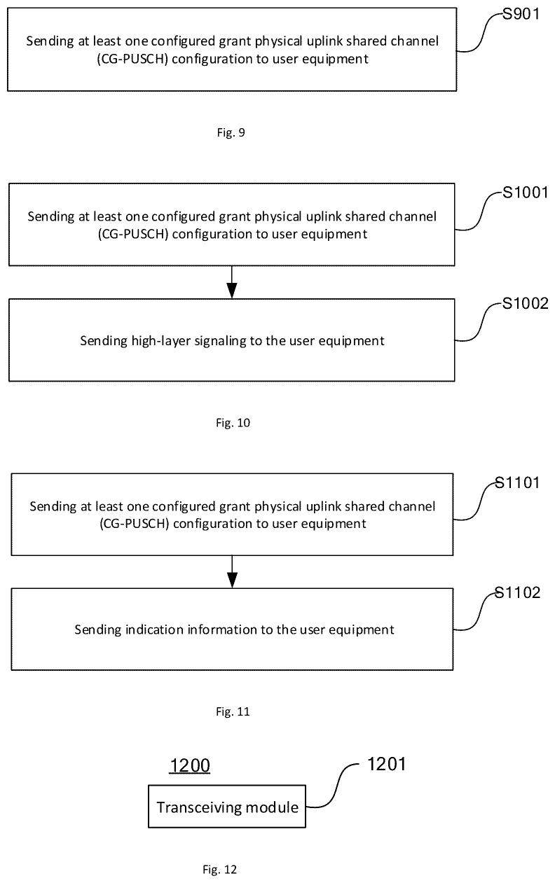

An example of the disclosure provides a method for receiving resource configuration information, performed by user equipment. FIG. 8 is a flowchart of a method for receiving resource configuration information shown according to an example. As shown in FIG. 8, the method includes steps S801 to S802.

Step S801: at least one configured grant physical uplink shared channel (CG-PUSCH) configuration sent by a network device is received.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last a CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be detected by the network device in a belonging period can be accurately indicated.

Step S802: indication information sent by the network device is received.

The user equipment determines according to the indication information that a number of CG-PUSCH resources included in each period of the CG-PUSCH configuration is indicated as non-numeric information.

When the number of CG-PUSCH resources included in each period is indicated as the non-numeric information, it shows that the number of CG-PUSCH resources included in each period is not fixed, the number of CG-PUSCH resources is determined according to actual scheduling situations, and the number in different periods may be the same or not.

An example of the disclosure provides a method for sending resource configuration information, performed by a network device. FIG. 9 is a flowchart of a method for sending resource configuration information shown according to an example. As shown in FIG. 9, the method includes step S901.

Step S901: at least one configured grant physical uplink shared channel (CG-PUSCH) configuration is sent to user equipment.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be further detected in a belonging period can be accurately determined.

An example of the disclosure provides a method for sending resource configuration information, performed by a network device. FIG. 10 is a flowchart of a method for sending resource configuration information shown according to an example. As shown in FIG. 10, the method includes steps S1001 to S1002.

Step S1001: at least one configured grant physical uplink shared channel (CG-PUSCH) configuration is sent to user equipment.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be further detected in a belonging period can be accurately determined.

Step S1002: high-layer signaling is sent to the user equipment.

The high-layer signaling includes information for indicating N, and the N is a number of CG-PUSCH resources included in each period of the CG-PUSCH configuration.

In an example, as shown in FIG. 4, N is 4 in a case that each period T includes four CG-PUSCH resources.

It needs to be noted that a sequential order of step S1001 and Step S1002 is not limited.

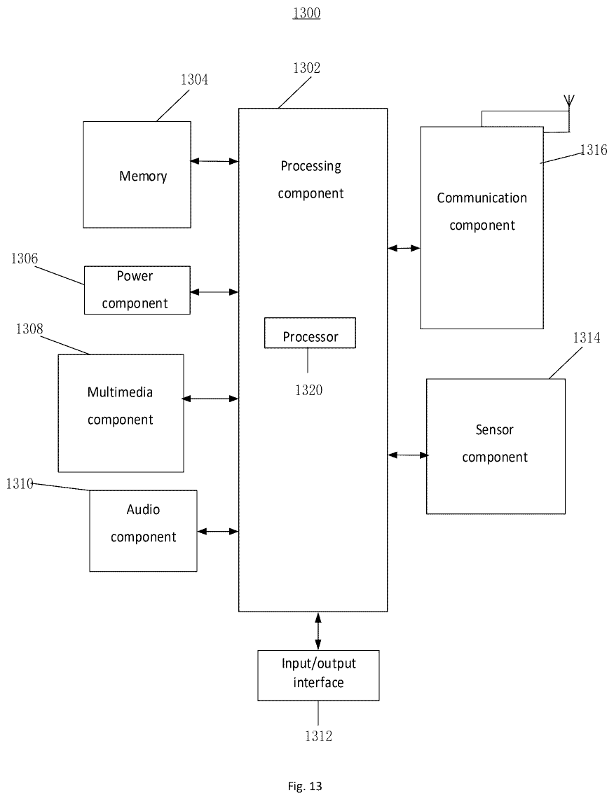

An example of the disclosure provides a method for sending resource configuration information, performed by a network device. FIG. 11 is a flowchart of a method for sending resource configuration information shown according to an example. As shown in FIG. 11, the method includes steps S1101 to S1102.

Step S1101: at least one configured grant physical uplink shared channel (CG-PUSCH) configuration is sent to user equipment.

Each period of the CG-PUSCH configuration includes a plurality of CG-PUSCH resources.

In some possible implementations, the plurality of CG-PUSCH resources in one period of the at least one CG-PUSCH configuration are on a time domain continuous resource.

In an example, in the plurality of CG-PUSCH resources in the one period in the at least one CG-PUSCH configuration, an end position of a previous CG-PUSCH resource is the same as a start position of a latter CG-PUSCH resource in any two adjacent CG-PUSCH resources.

It can be guaranteed that an uplink resource transmission is completed as soon as possible by the plurality of CG-PUSCH resources in the one period on the time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In an example, each time slot includes one CG-PUSCH resource, positions of symbols occupied by CG-PUSCH resources in the various time slots are the same, and thus overhead of the network device during resource allocation is reduced.

In an example, the plurality of CG-PUSCH resources in the one period in the at least one CG-PUSCH configuration are on the time slot continuous resource, namely, on a segment of the time slot continuous resource, and each time slot internally includes one CG-PUSCH resource.

In some possible implementations, it is determined that a CG-PUSCH resource which overlaps a downlink symbol of semi-persistent scheduling or a symbol where a Synchronization signal/PBCH block (SSB) is located is an invalid resource.

In some possible implementations, the CG-PUSCH resource which is the invalid resource is excluded from the number of CG-PUSCH resources included in one period.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, when the CG-UCI includes the second indication information, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

Through the above set feature, the number of CG-PUSCHs needing to be further detected in a belonging period can be accurately determined.

Step S1102: indication information is sent to the user equipment.

The user equipment determines according to the indication information that a number of CG-PUSCH resources included in each period of the CG-PUSCH configuration is indicated as non-numeric information.

When the number of CG-PUSCH resources included in each period is indicated as the non-numeric information, it shows that the number of CG-PUSCH resources included in each period is not fixed, the number of CG-PUSCH resources is determined according to actual scheduling situations, and the number in different periods may be the same or not.

Based on the concept the same as the above method example, an example of the disclosure further provides a communication apparatus. The communication apparatus may have functions of user equipment 102 in the above method example and may be configured to perform steps performed by the user equipment 102 provided by the above example. The functions may be implemented through hardware or software or by executing the corresponding software through hardware. The hardware or software includes one or more modules corresponding to the above functions.

In a possible implementation, the communication apparatus 1200 [ED1][ql2] shown in FIG. 12 may serve as the user equipment 102 involved in the above method example and perform the steps performed by the user equipment 102 in the above method example.

The communication apparatus 1200 includes a transceiving module 1201.

The transceiving module 1201 is configured to receive at least one configured grant physical uplink shared channel (CG-PUSCH) configuration sent by a network device, where each period of the CG-PUSCH configuration includes a plurality of CG-PUSCH resources.

In some possible implementations, the transceiving module 1201 is further configured to: receive high-layer signaling sent by the network device, where the high-layer signaling includes information for indicating N, and the N is a number of CG-PUSCH resources included in each period of the CG-PUSCH configuration.

In some possible implementations, the transceiving module 1201 is further configured to: receive indication information sent by the network device, and determine, according to the indication information, that a number of CG-PUSCH resources included in each period of the CG-PUSCH configuration is indicated as non-numeric information.

In some possible implementations, the plurality of CG-PUSCH resources in one period of the at least one CG-PUSCH configuration are on a time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

In some possible implementations, the transceiving module 1201 is further configured to: determine that a CG-PUSCH resource which overlaps a downlink symbol of semi-persistent scheduling or a symbol where a Synchronization signal/PBCH block (SSB) is located is an invalid resource.

In some possible implementations, the transceiving module 1201 is further configured to: exclude the CG-PUSCH resource which is the invalid resource from the number of CG-PUSCH resources included in one period.

When the communication apparatus is the user equipment, its structure may further be shown in FIG. 13. FIG. 13 is a structural diagram of an apparatus 1300 for receiving resource configuration information shown according to an example. For example, the apparatus 1300 may be a mobile phone, a computer, a digital broadcast terminal, a messaging device, a game console, a tablet device, a medical device, a fitness facility, a personal digital assistant and the like.

Referring to FIG. 13, the apparatus 1300 may include one or more components as follows: a processing component 1302, a memory 1304, a power component 1306, a multimedia component 1308, an audio component 1310, an input/output (I/O) interface 1312, a sensor component 1314 and a communication component 1316.

The processing component 1302 generally controls whole operations of the apparatus 1300, such as operations related to display, phone call, data communication, camera operations and recording operations. The processing component 1302 may include one or more processors 1320 for executing instructions so as to complete all or part of steps of the above method. Besides, the processing component 1302 may include one or more modules to facilitate interaction between the processing component 1302 and the other components. For example, the processing component 1302 may include a multimedia module so as to facilitate interaction between the multimedia component 1308 and the processing component 1302.

The memory 1304 is configured to store various types of data so as to support operations on the apparatus 1300. Examples of these data include instructions of any application program or method, contact person data, telephone directory data, messages, pictures, videos and the like for operations on the apparatus 1300. The memory 1304 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power component 1306 provides power for various components of the apparatus 1300. The power component 1306 may include a power management system, one or more power sources, and other components related to power generation, management and distribution for the apparatus 1300.

The multimedia component 1308 includes a screen which provides an output interface between the apparatus 1300 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to the touching or swiping operation. In some examples, the multimedia component 1308 includes a front camera and/or a back camera. When the apparatus 1300 is in an operation mode, such as a photographing mode or a video mode, the front camera and/or the back camera may receive external multimedia data. Each front camera and each back camera may be a fixed optical lens system or have a focal length and an optical zoom capability.

The audio component 1310 is configured to output and/or input an audio signal. For example, the audio component 1310 includes a microphone (MIC). When the apparatus 1300 is in the operation mode, such as a call mode, a recording mode and a voice recognition mode, the microphone is configured to receive an external audio signal. The received audio signal may be further stored in the memory 1304 or sent via the communication component 1316. In some examples, the audio component 1310 further includes a speaker for outputting the audio signal.

The I/O interface 1312 provides an interface between the processing component 1302 and a peripheral interface module, and the above peripheral interface module may be a keyboard, a click wheel, buttons and the like. These buttons may include but are not limited to: a home button, a volume button, a start button and a lock button.

The sensor component 1314 includes one or more sensors, configured to provide state evaluation of various aspects for the apparatus 1300. For example, the sensor component 1314 may detect a start/shut-down state of the apparatus 1300 and relative positioning of the components, for example, the components are a display and a keypad of the apparatus 1300. The sensor component 1314 may further detect location change of the apparatus 1300 or one component of the apparatus 1300, whether there is contact between a user and the apparatus 1300, an azimuth or acceleration and deceleration of the apparatus 1300 and temperature change of the apparatus 1300. The sensor component 1314 may include a proximity sensor, configured to detect existence of a nearby object without any physical contact. The sensor component 1314 may further include an optical sensor, such as a CMOS or CCD image sensor, for use in imaging application. In some examples, the sensor component 1314 may further include an acceleration sensor, a gyroscope sensor, a magnetic sensor, a pressure sensor or a temperature sensor.

The communication component 1316 is configured to facilitate wired or wireless communication between the apparatus 1300 and other devices. The apparatus 1300 may be accessed to a wireless network based on a communication standard, such as WiFi, 4G or 5G, or their combination. In an example, the communication component 1316 receives a broadcast signal or broadcast-related information from an external broadcast management system via a broadcast channel. In an example, the communication component 1316 further includes a near-field communication (NFC) module so as to facilitate short-range communication. For example, the NFC module may be implemented based on a radio frequency identification (RFID) technology, an infra-red data association (IrDA) technology, an ultra wide band (UWB) technology, a Bluetooth (BT) technology and other technologies.

In an example, the apparatus 1300 may be implemented by one or more than one application specific integrated circuit (ASIC), digital signal processor (DSP), digital signal processing device (DSPD), programmable logic device (PLD), field-programmable gate array (FPGA), controller, micro control unit, microprocessor or other electronic elements for executing the above method.

In an example, a non-transitory computer-readable storage medium including instructions is further provided, such as a memory 1304 including the instructions. The above instructions may be executed by a processor 1320 of an apparatus 1300 so as to complete the above method. For example, the non-transitory computer-readable storage medium may be an ROM, a random-access memory (RAM), a CD-ROM, a magnetic tape, a floppy disk, an optical data storage device and the like.

Based on the concept the same as the above method example, an example of the disclosure further provides a communication apparatus. The communication apparatus may have functions of a network device 101 in the above method example and may be configured to perform steps performed by the network device 101 provided by the above example. The functions may be implemented through hardware or software or by executing the corresponding software through hardware. The hardware or software includes one or more modules corresponding to the above functions.

In a possible implementation, the communication apparatus 1400 shown in FIG. 14 may serve as the network device 101 involved in the above method example and execute the steps executed by the network device 101 in the above method example.

The communication apparatus 1400 [ED3][ql4] shown in FIG. 14 includes a transceiving module 1401 configured to perform the steps performed by the network device 101 in the above method example.

The transceiving module 1401 is configured to send at least one configured grant physical uplink shared channel (CG-PUSCH) configuration to user equipment, where each period of the CG-PUSCH configuration includes a plurality of CG-PUSCH resources.

In some possible implementations, the transceiving module 1401 is further configured to: send high-layer signaling to the user equipment, where the high-layer signaling includes information for indicating N, and the N is a number of CG-PUSCH resources included in each period of the CG-PUSCH configuration.

In some possible implementations, the transceiving module 1401 is further configured to: send indication information to the user equipment, where the indication information is used for determining that a number of CG-PUSCH resources included in each period of the CG-PUSCH configuration is indicated as non-numeric information.

In some possible implementations, the plurality of CG-PUSCH resources in one period of the at least one CG-PUSCH configuration are on a time domain continuous resource.

In some possible implementations, different CG-PUSCH resources in the at least one CG-PUSCH configuration are located in different time slots, and positions of symbols occupied by the various CG-PUSCH resources in corresponding time slots are the same.

In some possible implementations, the CG-PUSCH is configured to transmit different transport blocks (TBs).

In some possible implementations, the CG-PUSCH is configured for a first transmission of data or a retransmission of data.

In some possible implementations, the CG-PUSCH includes configured grant uplink control information (CG-UCI), the CG-UCI includes first indication information, and the first indication information is configured to indicate the first transmission or retransmission.

In some possible implementations, the CG-PUSCH includes configured grant uplink control information (CG-UCI), the CG-UCI includes second indication information, and the second indication information is configured to indicate whether the CG-PUSCH meets a set characteristic in a period to which the CG-PUSCH belongs.

In some possible implementations, the set characteristic is one of the following: a last CG-PUSCH with an uplink data transmission in the period to which the CG-PUSCH belongs; a previous CG-PUSCH of a last CG-PUSCHs with the uplink data transmission in the period to which the CG-PUSCH belongs; or there being a set number of CG-PUSCHs to be transmitted between the CG-PUSCH and end of the period to which the CG-PUSCH belongs.

In some possible implementations, the transceiving module 1401 is further configured to: determine that a CG-PUSCH resource which overlaps a downlink symbol of semi-persistent scheduling or a symbol where a Synchronization signal/PBCH block (SSB) is located is an invalid resource.

In some possible implementations, the transceiving module 1401 is further configured to: exclude the CG-PUSCH resource which is the invalid resource from the number of CG-PUSCH resources included in one period.

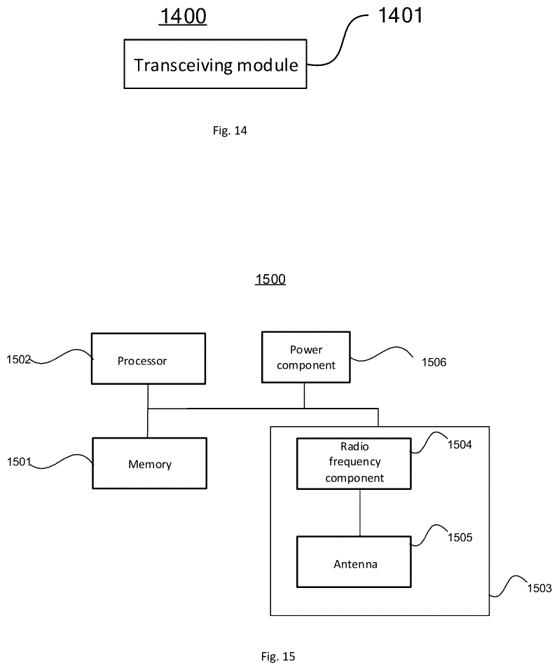

When the communication apparatus is the network device 101, its structure may further be shown in FIG. 15. As shown in FIG. 15, the apparatus 1500 includes a memory 1501, a processor 1502, a transceiving component 1503 and a power component 1506. The memory 1501 is coupled with the processor 1502 and may be configured to store program and data needed for implementing the functions by the communication apparatus 1500. The processor 1502 is configured to support the communication apparatus 1500 for performing the corresponding functions in the above method, and the functions may be implemented by calling the program stored in the memory 1501. The transceiving component 1503 may be a wireless transceiver and may be configured to support the communication apparatus 1500 for receiving signaling and/or data and sending signaling and/or data through a wireless radio. The transceiving component 1503 may also be called a transceiving unit or a communication unit and may include a radio frequency component 1504 and one or more antennas 1505. The radio frequency component 1504 may be a remote radio unit (RRU), and may be specifically configured for transmission of a radio frequency signal and conversion between the radio frequency signal and a baseband signal. The one or more antennas 1505 may be specifically configured for radiation and receiving of the radio frequency signal.

When the communication apparatus 1500 needs to send data, the processor 1502 performs baseband processing on the to-be-sent data, and then outputs a baseband signal to the radio unit, the radio unit performs radio frequency processing on the baseband signal and then sends a radio frequency signal in a form of electromagnetic wave through the antenna. When data is sent to the communication apparatus 1500, the radio unit receives a radio frequency signal through the antenna, converts the radio frequency signal to a baseband signal and then outputs the baseband signal to the processor 1502, and the processor 1502 converts the baseband signal to data and processes the data.

Those skilled in the art will easily figure out other implementation solutions of the examples of the disclosure after considering the specification and practicing the disclosure disclosed here. The present application intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

### Industrial Applicability

The at least one configured grant physical uplink shared channel (CG-PUSCH) configuration sent by the network device is received by the user equipment, a service may be transmitted through the plurality of CG-PUSCH resources in each period of the CG-PUSCH configuration, thus when a data volume of each frame of the transmitted service is large, all service data can be transmitted by using the PUSCH resources in one period, and energy consumption of the user equipment is reduced.

1. A method for receiving resource configuration information, performed by user equipment, comprising:
receiving at least one configured grant physical uplink shared channel (CG-PUSCH) configuration sent by a network device, wherein each period of the CG-PUSCH configuration comprises a plurality of CG-PUSCH resources.

2. The method according to claim 1, further comprising:
receiving high-layer signaling sent by the network device, wherein the high-layer signaling comprises information for indicating N, and the N is a number of CG-PUSCH resources comprised in each period of the CG-PUSCH configuration.

3. The method according to claim 1, further comprising:
receiving indication information sent by the network device, and
determining, according to the indication information, that a number of CG-PUSCH resources comprised in each period of the CG-PUSCH configuration is indicated as non-numeric information.

4. The method according to claim 1, wherein
the plurality of CG-PUSCH resources in one period of the at least one CG-PUSCH configuration are on a time domain continuous resource; or
different CG-PUSCH resources in the at least one CG-PUSCH configuration are located in different time slots, and positions of symbols occupied by the different CG-PUSCH resources in corresponding time slots are the same.

5-6. (canceled)

7. The method according to claim 1, wherein the CG-PUSCH is configured for a first transmission of data or a retransmission of data.

8. The method according to claim 7, wherein the CG-PUSCH comprises configured grant uplink control information (CG-UCI), the CG-UCI comprises at least one of first indication information or second indication information;
the first indication information indicates the first transmission or the retransmission;
the second indication information indicates whether the CG-PUSCH meets a set characteristic in a period in which the CG-PUSCH is located.

9. (canceled)

10. The method according to claim 8, wherein the set characteristic met by the CG-PUSCH in the period in which the CG-PUSCH is located comprises one of the following:
a last CG-PUSCH with an uplink data transmission in the period in which the CG-PUSCH is located;
a previous CG-PUSCH of a last CG-PUSCHs with the uplink data transmission in the period in which the CG-PUSCH is located; or
there being a set number of CG-PUSCHs to be transmitted between the CG-PUSCH and end of the period in which the CG-PUSCH is located.

11. The method according to claim 4, further comprising:
determining that a CG-PUSCH resource which overlaps a downlink symbol of semi-persistent scheduling or a symbol where a Synchronization signal/PBCH block (SSB) is located is an invalid resource.

12. The method according to claim 11, further comprising:
excluding the CG-PUSCH resource which is the invalid resource from the number of CG-PUSCH resources comprised in one period.

13. A method for sending resource configuration information, performed by a network device, comprising:
sending at least one configured grant physical uplink shared channel (CG-PUSCH) configuration to user equipment, where each period of the CG-PUSCH configuration comprises a plurality of CG-PUSCH resources.

14. The method according to claim 13, further comprising:
sending high-layer signaling to the user equipment, wherein the high-layer signaling comprises information for indicating N, and the N is a number of CG-PUSCH resources comprised in each period of the CG-PUSCH configuration.

15. The method according to claim 13, further comprising:
sending indication information to the user equipment, wherein the indication information is used for determining that a number of CG-PUSCH resources comprised in each period of the CG-PUSCH configuration is indicated as non-numeric information.

16. The method according to claim 13, wherein the plurality of CG-PUSCH resources in one period of the at least one CG-PUSCH configuration are on a time domain continuous resource; or
different CG-PUSCH resources in the at least one CG-PUSCH configuration are located in different time slots, and positions of symbols occupied by the different CG-PUSCH resources in corresponding time slots are the same.

17-18 (canceled)

19. The method according to claim 13, wherein the CG-PUSCH is configured for a first transmission of data or a retransmission of data.

20. The method according to claim 19, wherein the CG-PUSCH comprises configured grant uplink control information (CG-UCI), the CG-UCI comprises at least one of first indication information or second indication information;
the first indication information indicates the first transmission or the retransmission;
the second indication information indicates whether the CG-PUSCH meets a set characteristic in a period in which the CG-PUSCH is located.

21. (canceled)

22. The method according to claim 20, wherein the set characteristic met by the CG-PUSCH in the period in which the CG-PUSCH is located comprises one of the following:
a last CG-PUSCH with an uplink data transmission in the period in which the CG-PUSCH is located;
a previous CG-PUSCH of a last CG-PUSCHs with the uplink data transmission the period in which the CG-PUSCH is located; or
there being a set number of CG-PUSCHs to be transmitted between the CG-PUSCH and end of the period in which the CG-PUSCH is located.

23. The method according to claim 16, further comprising:
determining that a CG-PUSCH resource which overlaps a downlink symbol of semi-persistent scheduling or a symbol where a Synchronization signal/PBCH block (SSB) is located is an invalid resource.

24. The method according to claim 23, further comprising:
excluding the CG-PUSCH resource which is the invalid resource from the number of CG-PUSCH resources comprised in one period.

25-26. (canceled)

27. A communication apparatus, comprising a processor and a memory, wherein
the memory is configured to store a computer program; and
the processor is configured to perform the computer program so as to implement a method for receiving resource configuration information, comprising: receiving at least one configured grant physical uplink shared channel (CG-PUSCH) configuration sent by a network device, wherein each period of the CG-PUSCH configuration comprises a plurality of CG-PUSCH resources.

28. A communication apparatus, comprising a processor and a memory, wherein
the memory is configured to store a computer program; and
the processor is configured to perform the computer program so as to implement the method according to claim 13.

29-30. (canceled)
